(19) United States
(12) Patent Application Publication
(10) Pub. No.: US 2026/0272786 A1
(43) Pub. Date: Sep. 17, 2026

(54) Internally Anchored, Tape-Free Nasal Tube

(71) Applicant: Good Doctor Biotechnology Co., Ltd., Pingtung County (TW)

(72) Inventor: PI-YIN LIN, Pingtung County (TW)

(21) Appl. No.: 19/553,483

(22) Filed: Mar. 2, 2026

(30) Foreign Application Priority Data
Mar. 14, 2025 (TW) 114109616

(51) Int. Cl. A61J 15/00

(52) U.S. Cl. CPC A61J 15/0003; A61J 15/0061

(57) ABSTRACT

Conventional nasogastric tubes are typically secured to the nasal area using adhesive tape. This method increases the cost associated with adhesive materials and may cause skin tears or injuries when the tape is removed. A nasogastric tube with at least one elastic arm attached to the tube cap or the tube body is provided, enabling the nasogastric tube to be internally anchored within the nostril. During use, the elastic arms attached to the tube cap or tube body are first pressed inward. After being compressed and deformed, the elastic arms are inserted into the nostril. Once inside the nostril, the elastic arms rebound and expand. After expansion, the overall outer diameter of the nasogastric tube defined by the elastic arms is greater than the maximum diameter of the nostril, thereby preventing the tube from slipping out of the nostril and securely fixing the nasogastric tube in place.

### CROSS REFERENCE TO RELATED APPLICATION

The application claims the benefit of Taiwan application serial No. 114109616, filed on Mar. 14, 2025, and the entire contents of which are incorporated herein by reference.

### BACKGROUND OF THE INVENTION

### 1. Field of the Invention

The present invention relates to a medical device and, more particularly, to a device that can fix a nasal tube within a nostril without requiring tape.

### 2. Description of the Related Art

Patients who have difficulty chewing or swallowing due to aging or disease, or comatose and bedridden patients, have difficulty eating through mouth. To maintain bodily functions, a nasal tube must be installed. A nasal tube is a tube that passes from a nostril through pharynx and esophagus, and finally reaches stomach. In this way, food can be infused into a patient’s stomach through the nasal tube, enabling the patient to obtain sufficient nutrition to maintain bodily functions.

An end of a nasal tube is exposed outside a patient’s nostril, to prevent the nasal tube from sliding out of or retracting into the patient’s nostril, the exposed portion of the nasal tube is usually adhered to skin of the patient’s face with tape. However, using tape to fix the nasal tube not only increases the cost but also may cause a skin laceration when removing the tape.

In view of this, it is necessary to improve the conventional method for fixing a nasal tube.

### SUMMARY OF THE INVENTION

To solve the above problems, it is an objective of the present invention to provide an internally anchored, tape-free nasal tube that can fix the nasal tube at a patient’s nostril without requiring tape adhesion, and can achieve effects of saving tape costs, avoiding lacerations caused by tape removal, and improving facial aesthetics for the patient.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, terms “first”, “second” and similar terms used throughout the present invention are mainly used to distinguish between different elements or features (which may be components, directions, steps, etc.), and not to indicate the maximum or minimum number of such elements or features in a corresponding subject or method, nor to define any sequence.

As used herein, the term “engagement”, “coupling”, “assembly”, or similar terms is used to include separation of connected members without destroying the members after connection or inseparable connection of the members after connection. A person having ordinary skill in the art would be able to select according to desired demands in the material or assembly of the members to be connected.

An internally anchored, tape-free nasal tube according to the present invention includes a tube body having a feeding port and a cap positioning member. The cap positioning member has a coupling portion. The coupling portion is detachably coupled to the feeding port. A blocking portion laterally extends from a side surface of the cap positioning member. The cap positioning member has at least one cap elastic arm, an elastic deformation space is provided between the at least one cap elastic arm and the coupling portion, and the at least one cap elastic arm has an extension end and a connection end, with the connection end connected to the coupling portion.

Therefore, the internally anchored, tape-free nasal tube of the present invention allows a coupling portion of a positioning member to be coupled to a feeding port to cover a tube body; a blocking portion of a cap positioning member can abut against an exterior of a patient’s nose, such that the feeding port of the tube body can be positioned at the patient’s nostril without retracting into a nasal cavity; the cap positioning member has at least one cap elastic arm, and the at least one cap elastic arm can be inserted into the nostril after being pressed inward and deformed. When the at least one cap elastic arm enters the nostril, the at least one cap elastic arm will rebound and expand, and an elastic deformation space can be formed after expansion. Because an overall outer diameter of the nasal tube, defined by the at least one elastic arm, is larger than a maximum inner diameter of the nostril, the nasal tube can be fixed within the nostril and will not slide out of the nostril. Thus, it is no longer needed to fix the nasal tube externally with tape.

In an example, the positioning member has a first end and a second end opposite to the first end, the coupling portion is located between the first end and the second end, the coupling portion has a large diameter section and a tapered section, the large diameter section is coupled to the feeding port, and a radial dimension of the tapered section gradually tapers from the large diameter section toward the second end. Thus, the coupling portion can achieve an effect of easily entering the feeding port through a tapered section.

In an example, the cap positioning member has a gripping portion, and the gripping portion and the coupling portion are respectively located at two opposite ends of the positioning member. Thus, a gripping portion can be held by a patient or medical personnel to achieve an effect of facilitating application of force to separate the positioning member from the feeding port.

In an example, the at least one cap elastic arm has an expansion portion, and the expansion portion has a maximum width of 5 to 15 mm in an extension direction from the connection end to the extension end. Thus, an expansion portion can achieve an effect of providing a larger contact area with an inner wall of the nasal cavity.

In an example, the at least one cap elastic arm has a connection end, the connection end is connected to the coupling portion, the at least one cap elastic arm has two branch arms, and the two branch arms are bifurcated from the connection end to form two extension ends in an extension direction. Thus, two branch arms can provide a larger contact area with the inner wall of the nasal cavity, so that the at least one elastic arm can achieve an effect of better abutment stability against the inner wall of the nasal cavity.

In an example, the positioning member has a plurality of cap elastic arms, and the plurality of cap elastic arms is spaced apart in a circumferential direction of the coupling portion. Thus, through a plurality of elastic arms, the positioning member can further achieve an effect of better abutment stability against the inner wall of the nasal cavity.

In an example, the cap elastic arm has an extension end and a connection end, the connection end is connected to the coupling portion of the positioning member, and the extension end is coupled to the tube body. Thus, the cap positioning member can be connected to the tube body through the at least one cap elastic arm, achieving an effect of preventing the positioning member from being lost or dropped.

In an example, the tube body has at least one tube body elastic arm, and the at least one tube body elastic arm protrudes from an outer peripheral wall of the tube body. Thus, a tube body elastic arm can be inserted into the nostril after being pressed inward and deformed. When the tube body elastic arm enters the nostril, the tube body elastic arm will rebound and expand, and an elastic deformation space can be formed after expansion. Because an overall outer diameter of the nasal tube, defined by the tube body elastic arms, is larger than a maximum inner diameter of the nostril, the nasal tube can be fixed within the nostril and will not slide out of the nostril. Thus, it is no longer needed to fix the nasal tube externally with tape.

In an example, at least one end of the at least one tube body elastic arm is coupled to the outer peripheral wall of the tube body, such that the at least one tube body elastic arm is in an arc shape arched from the outer peripheral wall of the tube body. Thus, the at least one tube body elastic arm can form an abutment against the inner wall of the nasal cavity, so as to achieve an effect of positioning the tube body on the inner wall of the nasal cavity.

In an example, the tube body has a plurality of tube body elastic arms, and the plurality of tube body elastic arms is spaced apart in a circumferential direction of the outer peripheral wall of the tube body. Thus, a plurality of tube body elastic arms can achieve an effect of enabling the tube body to be stably propped against the inner wall of the nasal cavity.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an exploded perspective view of a first embodiment of the present invention.

FIG. 2 shows a cross-sectional view illustrating a usage condition of the first embodiment of the present invention.

FIG. 3 shows an assembled, cross-sectional view as shown in FIG. 2.

FIG. 4 shows an exploded perspective view of a second embodiment of the present invention.

FIG. 5 shows an exploded perspective view of a third embodiment of the present invention.

FIG. 6 shows an exploded perspective view of a fourth embodiment of the present invention.

FIG. 7 shows a perspective view of a fifth embodiment of the present invention.

FIG. 8 shows a cross-sectional view illustrating a usage condition of the fifth embodiment of the present invention.

FIG. 9 shows a perspective view of a sixth embodiment of the present invention.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, the preferred embodiments of the present invention will be described hereinafter in connection with the accompanying drawings. Furthermore, the elements designated by the same reference numeral in various figures will be deemed as identical, and the description thereof will be omitted.

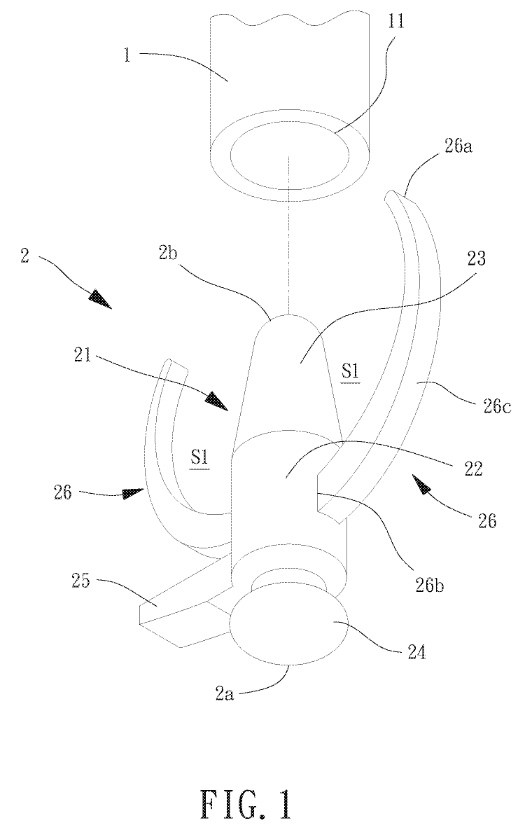

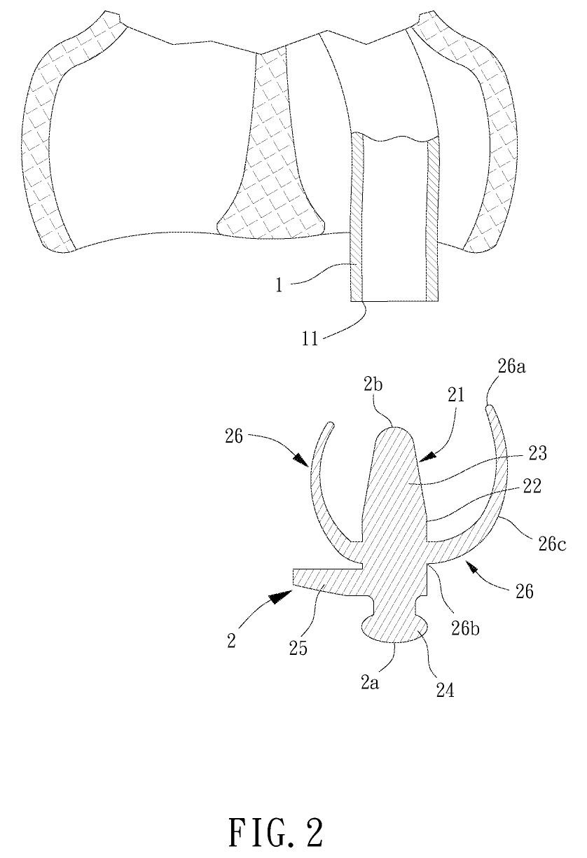

Please refer to FIGS. 1 and 2, which show a first embodiment of an internally anchored, tape-free nasal tube of the present invention. The internally anchored, tape-free nasal tube includes a tube body 1 and a cap positioning member 2, with the cap positioning member 2 detachably coupled to one end of the tube body 1.

The tube body 1 may be of a soft material such as plastic or silicone, so that one end of the tube body 1 can be inserted through a nostril of a patient, and pass through pharynx and esophagus to reach stomach. The tube body 1 may have an appropriate tube diameter according to a diameter of the patient’s gastroesophageal tract, so that the tube body 1 can easily pass through the pharynx and the esophagus and smoothly reach the stomach, so as to reduce the discomfort of the tube body 1 being inserted into the patient’s body. The other end of the tube body 1 has a feeding port 11, and the feeding port 11 can be exposed outside the patient’s nostril, so that liquid food can be delivered to the patient’s stomach through the feeding port 11.

The cap positioning member 2 is detachably coupled to the feeding port 11 of the tube body 1. For example, when the patient is being fed, the cap positioning member 2 can be removed from the feeding port 11. When the patient is not being fed, the cap positioning member 2 can form a closure for the feeding port 11 to prevent a foreign object or a pathogen from entering through the feeding port 11. Specifically, the cap positioning member 2 has a coupling portion 21. The coupling portion 21 can be substantially in a column shape, and the coupling portion 21 can form a closure for the feeding port 11 by being coupled to the feeding port 11. The positioning member 2 may have a first end 2a and a second end 2b opposite to the first end 2a, and the coupling portion 21 may be adjacent to the second end 2b. Furthermore, the coupling portion 21 may have a large diameter section 22, and a radial dimension of the large diameter section 22 may be slightly larger than a diameter of the feeding port 11. In this way, the coupling portion 21 can abut against the feeding port 11 through the large diameter section 22, so that the feeding port 11 forms a closure.

Preferably, the coupling portion 21 may have a tapered section 23, and a radial dimension of the tapered section 23 may gradually taper from the large diameter section 22 toward the second end 2b, so that the radial dimension of the tapered section 23 may be smaller than the diameter of the feeding port 11. In this way, the coupling portion 21 can easily enter the feeding port 11 through the tapered section 23. In addition, in this embodiment, the cap positioning member 2 may have a gripping portion 24, and the gripping portion 24 is located at the first end 2a, so that the gripping portion 24 and the coupling portion 21 can be respectively located at two opposite ends of the positioning member 2. The gripping portion 24 can be held by the patient or medical personnel for applying force to separate the cap positioning member 2 from the feeding port 11.

The cap positioning member 2 has a blocking portion 25, and the blocking portion 25 can laterally extend between the first end 2a and the second end 2b, so that the blocking portion 25 can be located on a side surface of the cap positioning member 2. An extension direction of the blocking portion 25 can be substantially perpendicular to a direction from the first end 2a to the second end 2b. Preferably, the blocking portion 25 can be located at the large diameter section 22. In this way, when the large diameter section 22 abuts against the feeding port 11, the blocking portion 25 can accordingly abut against an exterior of the patient’s nose, such as a lower edge of the patient’s nasal septum, thereby positioning the feeding port 11 of the tube body 1 at an opening of the patient’s nostril. Thus, the feeding port 11 can be prevented from retracting deep into a nasal cavity and becoming difficult to be removed.

The cap positioning member 2 may have at least one cap elastic arm 26. The at least one cap elastic arm 26 may be of a flexible material, and the at least one cap elastic arm 26 can laterally extend between the first end 2a and the second end 2b. Furthermore, the at least one cap elastic arm 26 has an extension end 26a and a connection end 26b, and the connection end 26b is connected between the first end 2a and the second end 2b. Preferably, the connection end 26b is connected to the large diameter section 22. In this embodiment, the cap positioning member 2 has two cap elastic arms 26, and the two elastic arms 26 can be respectively located on two opposite sides of the large diameter section 22. The at least one cap elastic arm 26 may have an arc portion 26c between the extension end 26a and the connection end 26b. With the arc portion 26c, the extension end 26a can face toward the direction of the second end 2b, so that an elastic deformation space S1 is provided between the at least one cap elastic arm 26 and the coupling portion 21. In this way, when the large diameter section 22 abuts against the feeding port 11, an elastic deformation of the arc portion 26c can enable the at least one cap elastic arm 26 to extend into the patient’s nasal cavity, and enable the at least one elastic arm 26 to abut against an inner wall of the patient’s nasal cavity through an elastic restoration of the arc portion 26c. Thus, the feeding port 11 of the tube body 1 can be positioned at the opening of the patient’s nostril and preventing the tube body 1 from sliding out of the nostril.

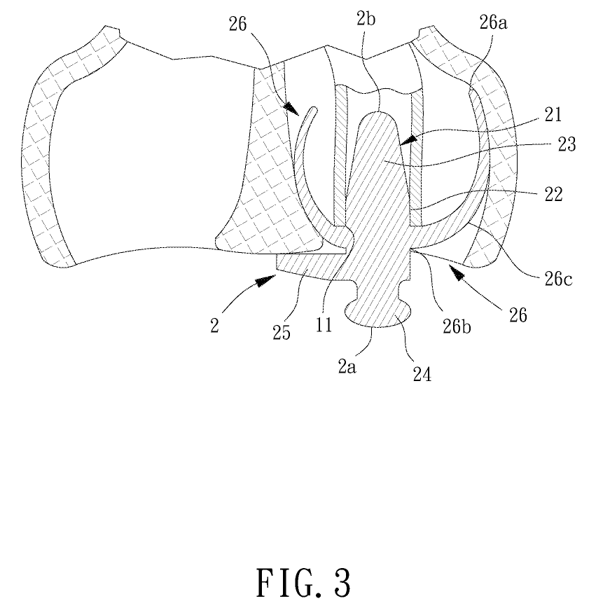

Please refer to FIG. 3. When the patient is not being fed, the cap positioning member 2 can be coupled to the feeding port 11, the tube body 1 can be pushed into the nasal cavity until the blocking portion 25 abuts against the exterior of the patient’s nose, and the at least one cap elastic arm 26 is pressed inward to deform so as to be inserted into the nostril. When the at least one cap elastic arm 26 enters the nostril, the at least one cap elastic arm 26 will rebound and expand, and the elastic deformation space S1 can be formed after expansion. Because an overall outer diameter of the cap positioning member 2, defined by the at least one cap elastic arm 26, is larger than a maximum inner diameter of the nostril, the feeding port 11 of the tube body 1 can be positioned at the patient’s nostril and will not slide out of the nostril. Thus, it is no longer needed to fix the nasal tube externally with tape.

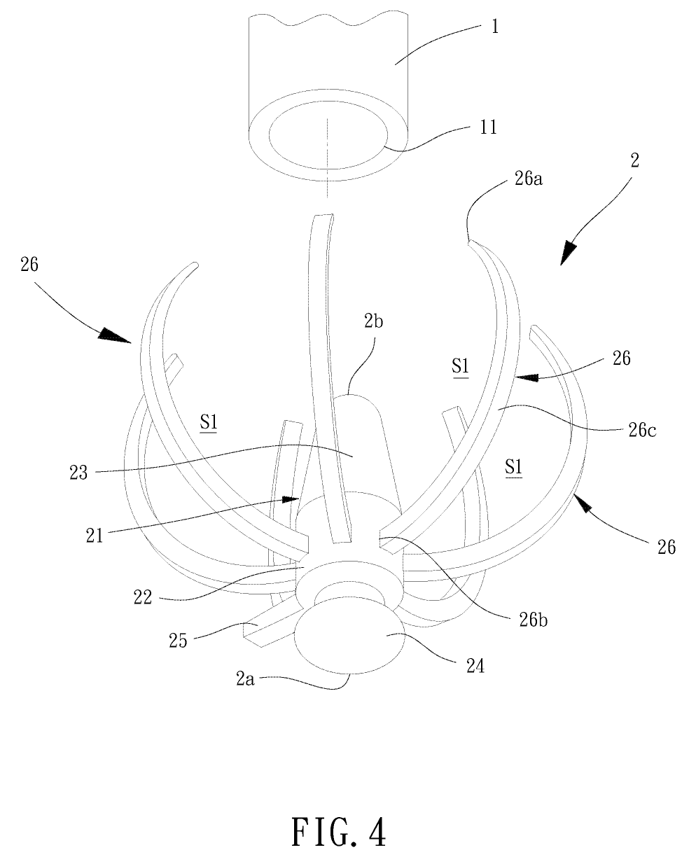

Please refer to FIG. 4, which shows a second embodiment of the internally anchored, tape-free nasal tube of the present invention. Compared with the first embodiment, in this embodiment, a number of the cap elastic arms 26 may be greater than two. The connection end 26b of each of the cap elastic arms 26 can be respectively connected to the large diameter section 22, and an extension end 26a of each of the cap elastic arms 26 can face toward a direction of the second end 2b. For example, when the number of the cap elastic arms 26 is greater than two, the plurality of cap elastic arms 26 may be spaced apart in a circumferential direction of the large diameter section 22. In this way, through the plurality of cap elastic arms 26, the cap positioning member 2 can further have better abutment stability against the inner wall of the nasal cavity. In addition, when the number of the cap elastic arms 26 is greater than two, a width of each of the cap elastic arms 26 can be reduced, making each of the cap elastic arms 26 more easily to deform and be inserted into the patient’s nasal cavity.

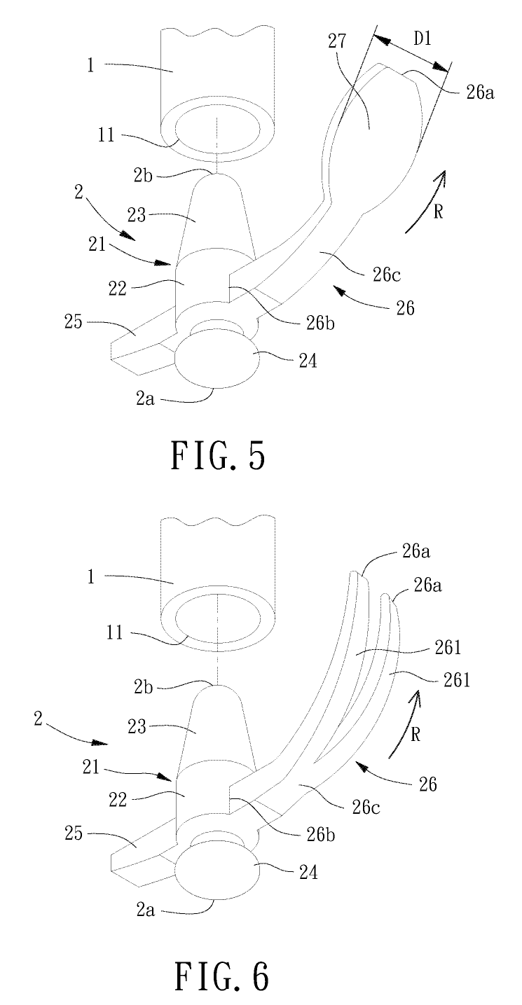

Please refer to FIG. 5, which shows a third embodiment of the internally anchored, tape-free nasal tube of the present invention. Compared with the first embodiment, in this embodiment, the cap elastic arm 26 has an expansion portion 27. The expansion portion 27 may be located between the extension end 26a and the connection end 26b. Preferably, the expansion portion 27 is adjacent to the extension end 26a. Further, the expansion portion 27 may have a greater width relative to the connection end 26b. Preferably, the expansion portion 27 may have a maximum width D in an extension direction R from the connection end 26b to the extension end 26a, and the maximum width D may be from 5 to 15 mm. In this way, the expansion portion 27 can have a larger contact area with the inner wall of the nasal cavity, so that the at least one cap elastic arm 26 can have better abutment stability against the inner wall of the nasal cavity.

Please refer to FIG. 6, which shows a fourth embodiment of the internally anchored, tape-free nasal tube of the present invention. Compared with the third embodiment, in this embodiment, the elastic arm 26 may have two branch arms 261. The two branch arms 261 may be bifurcated from the connection end 26b to form two extension ends 26a in the extension direction R. In this way, through the two branch arms 261, a width of the at least one elastic arm 26 can be increased. The two branch arms 261 can have a larger contact area with the inner wall of the nasal cavity, so that the at least one elastic arm 26 can have better abutment stability against the inner wall of the nasal cavity.

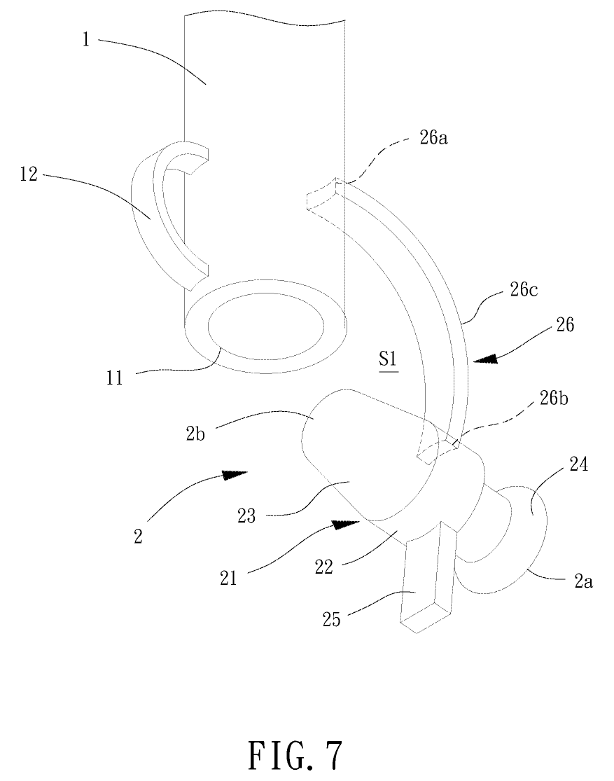

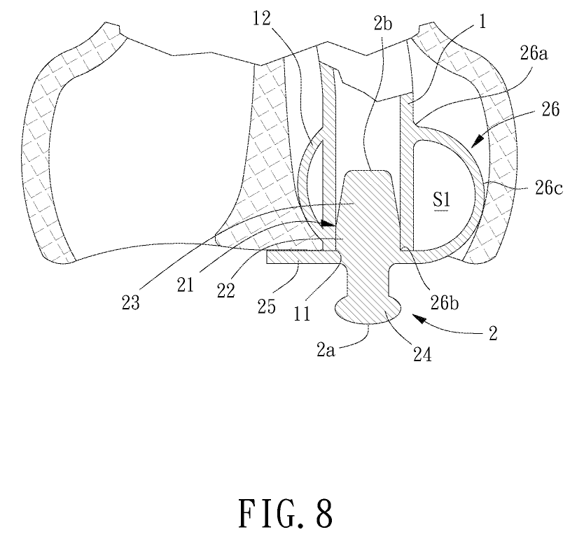

Please refer to FIGS. 7 and 8, which show a fifth embodiment of the internally anchored, tape-free nasal tube of the present invention. Compared with the first embodiment, in this embodiment, the cap elastic arm 26 has the extension end 26a and the connection end 26b, with the connection end 26b connected to the large diameter section 22, and with the extension end 26a coupled to the tube body 1. Furthermore, the extension end 26a is coupled to an outer peripheral wall of the tube body 1, and the extension end 26a may be adjacent to the feeding port 11. In this way, when the patient is being fed and the positioning member 2 is removed from the feeding port 11, by being connected to the tube body 1 through the elastic arm 26, the positioning member 2 can be prevented from being lost or dropped.

In addition, the tube body 1 may have at least one tube body elastic arm 12. At least one end of the at least one tube body elastic arm 12 is coupled to the outer peripheral wall of the tube body 1 and can form a protrusion from the outer peripheral wall of the tube body 1. The at least one tube body elastic arm 12 can be inserted into the nostril after being pressed inward and deformed. When the at least one tube body elastic arm 12 enters the nostril, the at least one tube body elastic arm 12 will rebound and expand, and an elastic deformation space can be formed after expansion. Because an overall outer diameter of the tube body 1 together with the cap positioning member 2, defined by the at least one tube body elastic arm 12 and the elastic arm 26, is larger than a maximum inner diameter of the nostril, the tube body elastic arm positions the feeding port 11 of the tube body 1 of the nasal tube at the opening of the patient’s nostril and will not slide out of the nostril. Thus, it is no longer needed to fix the nasal tube externally with tape.

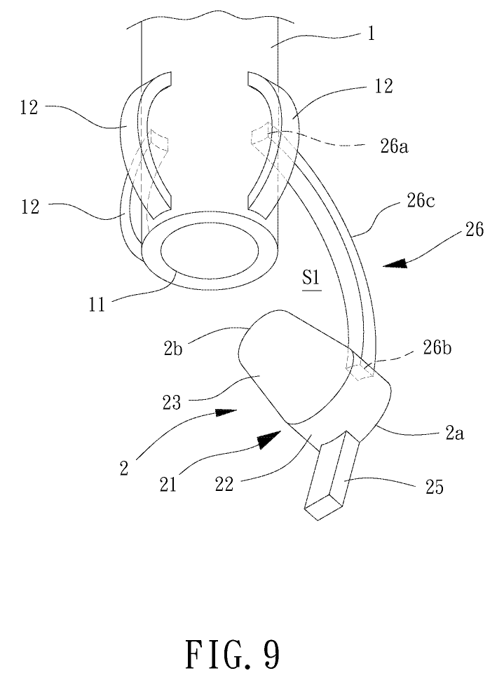

Please refer to FIG. 9, which shows a sixth embodiment of the internally anchored, tape-free nasal tube of the present invention. Compared with the fifth embodiment, in this embodiment, the gripping portion 24 of the first end 2a of the cap positioning member 2 may be omitted, so that the cap positioning member 2 does not form an obvious protrusion at the patient's nostril, which can achieve an effect of maintaining facial aesthetics. Also, the tube body 1 may have a plurality of the tube body elastic arms 12, and the plurality of tube body elastic arms 12 may be spaced apart in a circumferential direction of the outer peripheral wall of the tube body 1. In this way, the plurality of tube body elastic arms 12 can further enhance an abutment stability of the tube body 1 against the inner wall of the nasal cavity.

It is worth noted that the at least one tube body elastic arm 12 of the tube body 1 provided in the fifth embodiment can also be applied to the tube body 1 of other embodiments. In addition, in the foregoing embodiments, the gripping portion 24 of the first end 2a of the positioning member 2 may also be omitted, thereby further reducing an exposed volume of the cap positioning member 2. The contents disclosed in the above embodiments can be used individually or in combination according to usage requirements. The present invention is not limited to the forms disclosed in the drawings of the respective embodiments.

In summary, the internally anchored, tape-free nasal tube of the present invention enables a nasal tube to be anchored within a nostril by providing at least one elastic arm on a tube cap or the tube body. Using the internally anchored, tape-free nasal tube of the present invention eliminates the need to use tape for fixation, and can achieve effects of reducing tape costs, avoiding lacerations caused by tape removal, and improving facial aesthetics for a patient.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. An internally anchored, tape-free nasal tube, comprising:
a tube body having a feeding port; and
a cap positioning member having a coupling portion, wherein the coupling portion is detachably coupled to the feeding port, wherein a blocking portion laterally extends from a side surface of the cap positioning member, and wherein the cap positioning member has at least one cap elastic arm, an elastic deformation space is provided between the at least one cap elastic arm and the coupling portion, and the at least one cap elastic arm has an extension end and a connection end, with the connection end connected to the coupling portion.

2. The internally anchored, tape-free nasal tube as claimed in claim 1, wherein the positioning member has a first end and a second end opposite to the first end, the coupling portion is located between the first end and the second end, the coupling portion has a large diameter section and a tapered section, the large diameter section is coupled to the feeding port, and a radial dimension of the tapered section gradually tapers from the large diameter section toward the second end.

3. The internally anchored, tape-free nasal tube as claimed in claim 1, wherein the cap positioning member has a gripping portion, and the gripping portion and the coupling portion are respectively located at two opposite ends of the positioning member.

4. The internally anchored, tape-free nasal tube as claimed in claim 1, wherein the at least one cap elastic arm has an expansion portion, and the expansion portion has a maximum width of 5 to 15 mm in an extension direction from the connection end to the extension end.

5. The internally anchored, tape-free nasal tube as claimed in claim 1, wherein the at least one cap elastic arm has a connection end, the connection end is connected to the coupling portion, the at least one cap elastic arm has two branch arms, and the two branch arms are bifurcated from the connection end to form two extension ends in an extension direction.

6. The internally anchored, tape-free nasal tube as claimed in claim 1, wherein the positioning member has a plurality of cap elastic arms, and the plurality of cap elastic arms is spaced apart in a circumferential direction of the coupling portion.

7. The internally anchored, tape-free nasal tube as claimed in claim 1, wherein the cap elastic arm has an extension end and a connection end, the connection end is connected to the coupling portion of the positioning member, and the extension end is coupled to the tube body.

8. The internally anchored, tape-free nasal tube as claimed in claim 1, wherein the tube body has at least one tube body elastic arm, and the at least one tube body elastic arm protrudes from an outer peripheral wall of the tube body.

9. The internally anchored, tape-free nasal tube as claimed in claim 8, wherein at least one end of the at least one tube body elastic arm is coupled to the outer peripheral wall of the tube body, such that the at least one tube body elastic arm is in an arc shape arched from the outer peripheral wall of the tube body.

10. The internally anchored, tape-free nasal tube as claimed in claim 8, wherein the tube body has a plurality of tube body elastic arms, and the plurality of tube body elastic arms is spaced apart in a circumferential direction of the outer peripheral wall of the tube body.
